(19) United States
(12) Patent Application Publication
(10) Pub. No.: US 2007/0289548 A1
(43) Pub. Date: Dec. 20, 2007

(54) Portable pet shower and dryer apparatus

(76) Inventor: Jerry Wayne Smoot, Olton, TX (US)

Correspondence Address: AARON R. CLEMENTS/HURLEY, REYES & GUINN, 1805-13TH ST., LUBBOCK, TX, 79401, US

(21) Appl. No.: 10/862,010

(22) Filed: Jun. 4, 2004

Related U.S. Application Data
(60) Provisional application No. 60/475,599, filed on Jun. 4, 2003.

(51) Int. Cl. A01K 29/00; A47K 3/02

(52) U.S. Cl. 119/668; 119/675; 4/538

(57) ABSTRACT

An apparatus for bathing animals is disclosed in which a tub having two rotatably connected water distribution frames is provided. The water distribution frames are telescoping to allow for different size animals, and also to act to hold the animal in position within the apparatus. The tub has a water inlet and shampoo reservoir connected to the water distribution frames by a mixing valve. The upper portion of the apparatus includes a flexible enclosure which has four side panels, each of which has an inlet to allow a user to insert arms or bathing materials into the apparatus, and a top panel which includes a dryer system for drying the animal after bathing.

### CROSS REFERENCE TO RELATED APPLICATIONS

Reference is hereby made to provisional application No. 60/475,599, filed Jun. 4, 2003, from which priority is hereby claimed pursuant to 35 U.S.C. § 120.

### STATEMENT REGARDING FEDERALLY SPONSORED RESEARCH

Not Applicable.

### REFERENCE TO “MICROFICHE APPENDIX”

Not Applicable.

### BACKGROUND OF THE INVENTION

The present Invention is directed towards a portable pet washing device which allows the user to bathe and dry a pet while preventing shampoo and water used in the bathing process from being splashed by movement or resistance from the pet being bathed.

It is well known that a variety of problems are typically encountered while bathing and grooming pets. Many pets resist being bathed and must be restrained during the bathing process. Furthermore, when wet, many pets will instinctively attempt to shake water from their fur, which can throw the water a substantial distance. Traditional bathing methods generally involve washing in open tubs; due to these natural tendencies of pets, traditional methods generally result in the wetting of a large area surrounding the bathing area as well as the wetting of the person washing the pet. Also, the requirements of restraining the pet generally make it difficult for the person washing the pet to properly direct bathing water and to access implements needed for bathing, such as brushes and shampoo.

It is among the objects of this invention to provide a portable apparatus for bathing a pet which is lightweight, folds into a minimum volume for storage, is easy, reliable, and efficient to use, and permits a complete washing and drying of the pet without wetting or splashing the surrounding area or the user. It is furthermore among the objects of the invention to provide an apparatus which allows for the automatic mixing of shampoo with water and uniform distribution of the mixture over the pet to allow the user to concentrate efforts on bathing the pet and to make the bathing process more efficient

Prior attempts to solve some of these problems have resulted in a variety of devices. Prior efforts include such devices as Weinstein et al., U.S. Pat. No. 3,749,064, and Miller, U.S. Pat. No. 3,263,653, each of which is essentially a bag with an attached hose; Baker, U.S. Pat. No. 4,083,328, which includes a tub with a tent-like flexible upper bag; Kleman, U.S. Pat. No. 4,407,234, which includes a completely rigid housing within which the pet is placed; as well as more elaborate devices such as Yoshikawa, U.S. Pat. No. 4,730,576 and Cucchi et al., U.S. Pat. No. 5,845,604. While some of these prior efforts are collapsible for ease of storage, none of the prior solutions which are collapsible include built-in mechanisms for mixing shampoo with water in a system which then evenly distributes the mixture over the pet for more efficient washing, and none of the prior collapsible solutions incorporates a dryer unit. The present invention therefore represents an improvement upon the prior art in providing features which are typically associated with bulky, expensive, non-collapsible pet baths in collapsible frame.

### SUMMARY OF THE INVENTION

The present Invention provides a collapsible pet bath with efficient systems for mixing shampoo and other fur treatment chemicals with water and distributing the mixture over the subject pet as well as a system for drying the pet without removal from the apparatus. A basin is provided which consists essentially of a shallow rectangular tub which includes a plurality of holes in its bottom surface to allow for drainage of water from the tub. Furthermore, in one end wall of the tub, a water inlet is provided to which a standard water hose may be attached. Mounted to the inside of the walls of the tub, the distribution system for water and shampoo consists of a shampoo reservoir which is connected to the water inlet by means of a mixing valve, which allows the shampoo input to be regulated or terminated; the mixing valve is then connected to tubing which runs parallel to the inlet end wall. This tubing is rotatably connected at either end to a water distribution frame; the water distribution frames are mounted parallel to and connected rotatably to the side walls. The rotatable connection allows the water distribution frames to be rotated into a position within the tub (approximately parallel to the bottom of the tub) for storage, or into a fully extended position (approximately perpendicular to the bottom of the tub) to allow a pet to be placed within the invention. Each frame includes three parallel distribution tubes. The distance between the distribution tubes may be varied by means of compression fittings at either end of the distribution frames, which allow the end tubes of the distribution frames (which connect the three parallel water distribution tubes) to telescope. At one end of the distribution frames, the upper connecting end tubes include a curved portion which clamp around the neck of the pet to be bathed when the distribution frames are rotated down around the subject pet, thus providing the user with control over the animal.

Furthermore, along each upper edge of the side and end walls of the tub, a clear, flexible enclosure is connected. This flexible enclosure includes four side panels, each with an inlet port approximately centered in its corresponding panel. The flexible enclosure is connected to the upper edges of the walls of the tub by means of snaps or some other secure fastening means. The flexible enclosure is large enough for the tub to fit inside it, and the enclosure also includes a zipper along its bottom edge to allow it to be sealed with the tub inside it for storage. Thus, the device meets its goals of providing the user with an easy-to-use, collapsible system for bathing and drying a pet which includes a distribution system that holds the pet in place and distributes water and/or shampoo evenly around the pet. These and other features, aspects, and advantages of the present invention will become better understood with reference to the drawings and the following description.

### DESCRIPTION OF THE DRAWINGS

FIG. 1 is an oblique view of the invention without the flexible enclosure, showing the water distribution frames in their operative position.

FIG. 2 is an oblique view of the invention with the flexible enclosure, showing the water distribution frames in their operative position, and noting the blower units in each side of the flexible enclosure.

FIG. 3 is a top view of the flexible enclosure, showing both means for attaching the enclosure to the tub (snaps) and means for sealing the flexible enclosure around the tub for storage (zipper).

FIG. 4 includes an oblique view of the invention without the flexible enclosure, showing one of the water distribution frames rotated into its storage position.

FIG. 5 shows the invention without the flexible enclosure, with both water distribution frames rotated into their storage positions.

FIG. 6 shows additional detail of each of the side panels, particularly the securing tab.

FIG. 7 shows additional detail of the top panel and dryer system.

### CATALOG OF ELEMENTS

10 Tub
12 Tub drainage holes
14 Tub side walls
16 Tub forward end wall
18 Tub rear end wall
20 Water inlet connector
30 Shampoo reservoir
32 Mixing valve
34 Mixing valve t-joint
36 Connection point
38 Water dispensation device
100 Left water distribution tube
102 Left water distribution tube to water distribution frame connector
104 Left water distribution frame
110 Left water distribution frame hinges
120 Left lower water distribution tube
122 Left middle water distribution tube
124 Left upper water distribution tube
130 Left lower to middle water distribution frame end tubes
132 Left middle to upper water distribution frame rear end tube
134 Left middle to upper water distribution frame forward end tube
140 Left animal restraint water distribution frame tube
150 Left water distribution frame compression fittings
200 Right water distribution tube
202 Right water distribution tube to water distribution frame connector
204 Right water distribution frame
210 Right water distribution frame hinges
220 Right lower water distribution tube
222 Right middle water distribution tube
224 Right upper water distribution tube
230 Right lower to middle water distribution frame end tubes
232 Right middle to upper water distribution frame rear end tube
234 Right middle to upper water distrubution frame forward end tube
240 Right animal restraint water distribution frame tube
250 Right water distribution frame compression fittings
300 Flexible enclosure
310 Flexible enclosure forward side panel
312 Flexible enclosure forward side inlet
320 Flexible enclosure rear side
322 Flexible enclosure rear side inlet
330 Flexible enclosure left side
332 Flexible enclosure left side inlet
340 Flexible enclosure right side
342 Flexible enclosure right side inlet
350 Flexible enclosure snaps
360 Flexible enclosure edge zipper
370 Securing tab
400 Top panel
410 Dryer system
420 Blow dryer
430 Air distribution tube
440 Dryer slides

### DESCRIPTION OF THE PREFERRED EMBODIMENT

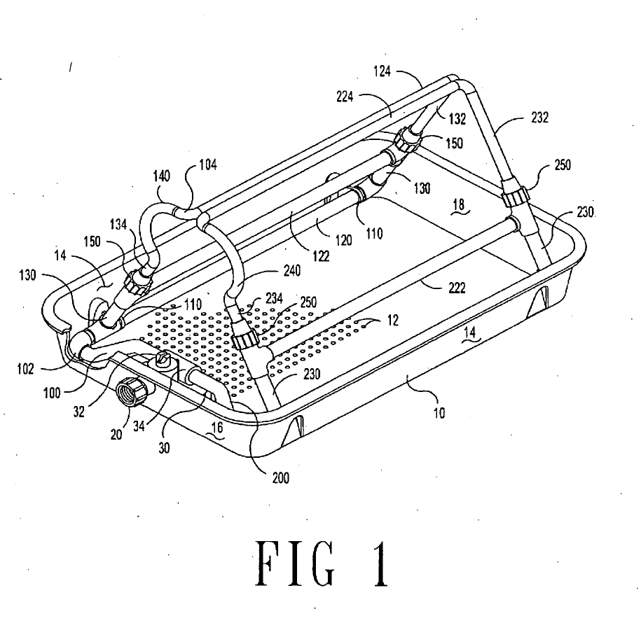

Referring to the drawings it may be seen in FIG. 1 that a tub 10 having left and right side walls 14, a forward end wall 16, and a rear end wall 18 is provided. It may further be seen that the tub includes tub drainage holes 12 in its bottom surface. Underneath the upper edge of the forward end wall 16, a water inlet connector 20 is mounted. Inside the forward wall of the tub, a mixing valve 32 connects the water inlet connector 20 and a shampoo reservoir 30 to the mixing valve t-joint 34. The mixing valve t-joint 34 is then connected to each of the left and right water distribution tubes 100 and 200, each of which extends from the midpoint of and substantially parallel to the forward end wall 16 to the corresponding side wall 14. Each water distribution tube 100 and 200 is rotatably connected to the lower forward corner of the corresponding left water distribution frame 104 or right water distribution frame 204. As an alternative embodiment, a connection point 36 may be provided at or approximately between the mixing valve t-joint 34 and left and right water distribution tubes 100 and 200 such that an additional water dispensation device 38, such as a shower head (with or without an integral cutoff valve), may be releasably affixed to the apparatus to provide water flow in addition to that provided by the water distribution frames 104 and 204.

Each water distribution frame 104 and 204 is rotatably connected to the corresponding side wall 14 by means of a pair of hinges 110 and 210 approximately located at the forward and rear ends of the corresponding lower water distribution tube 120 and 220. The left and right water distribution frames 104 and 204 are essentially identical to each other in operation and construction, although they are nonsuperimposable mirror images of each other due to the left and right animal restraint water distribution tubes 140 and 240. For this reason, it will be recognized that the following description of the left water distribution frame 104 applies similarly to the right water distribution frame 204.

Examining the left water distribution frame 104 in FIG. 1, one can see left lower, left middle, and left upper water distribution tubes 120, 122, and 124, which extend approximately parallel to the left side wall 14 and to each other. The forward and rear ends of the left lower water distribution tube 120 and left middle water distribution tube 122 are connected by the left lower to middle water distribution frame end tubes 130, which are identical. Similarly, the rear ends of the left middle water distribution tube 122 and left upper water distribution tube 124 are connected by the rear left middle to upper water distribution frame rear end tube 132. The forward ends of the left middle water distribution tube 122 and left upper water distribution tube 124 are connected by a combination of the left middle to upper water distribution frame forward tube 134 and left animal restraint tube 140. The outer diameter of the left middle to upper water distribution frame tubes 132 and 134 is approximately the same as the inner diameter of the left lower to middle water distribution frame tubes 130, such that each of the former tubes will slide into the corresponding latter tube. By this arrangement, the left water distribution frame 104 can be made to telescope to accommodate different sized animals. The left water distribution frame compression fittings 150 are provided to prevent leaks from the joint between the left middle to upper water distribution frame tubes 132 and 134 and the left lower to middle water distribution frame tubes 130, and the compression fittings 150 may be used to lock the joint at a given point. Combined with the drawings, those skilled in the art will readily understand the method of constructing the water distribution frames 104 and 204. Furthermore, while any tubular material may be used for these distribution frames, it will be understood that for purposes of weight, cost, durability, and ease of manufacture, the preferred material is polyvinyl chloride (PVC) tubing, which is a readily available material whose properties are well understood.

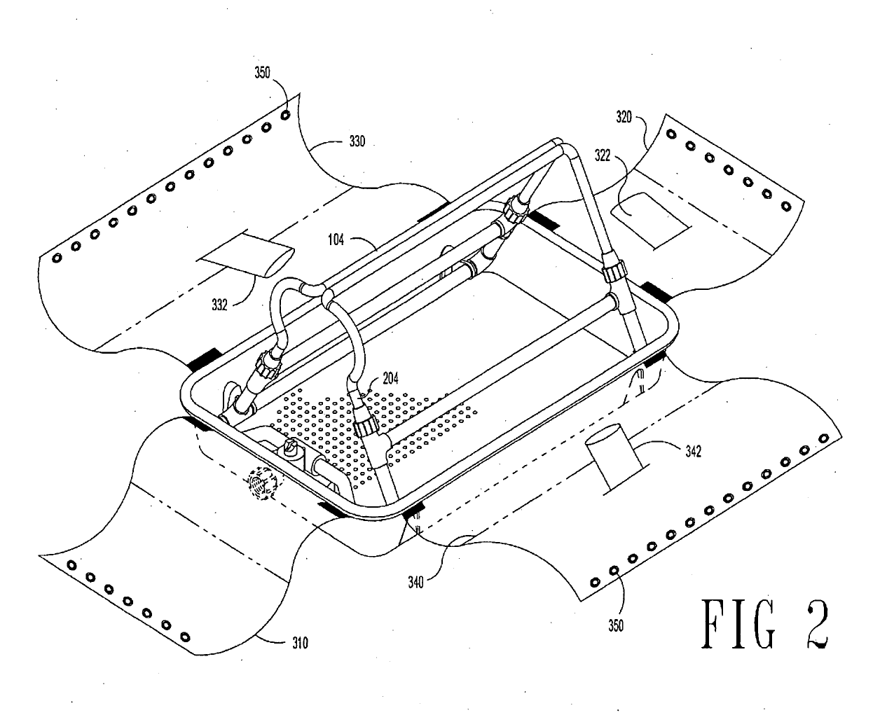

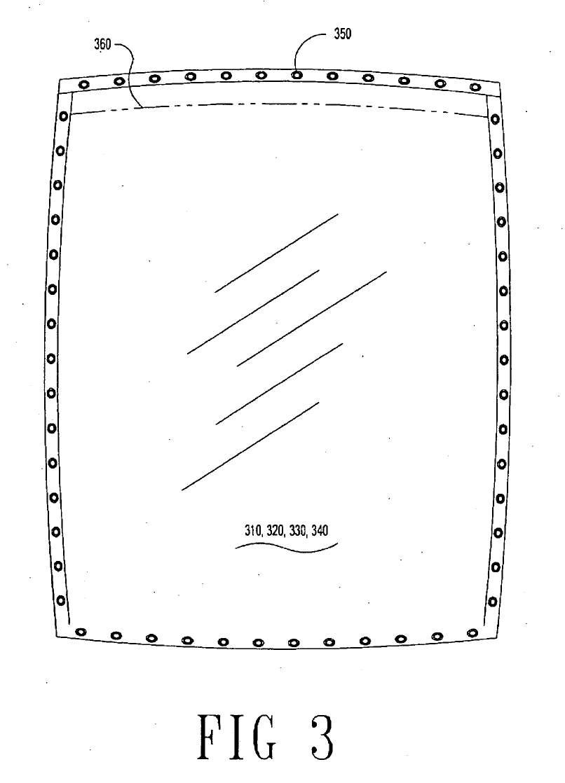

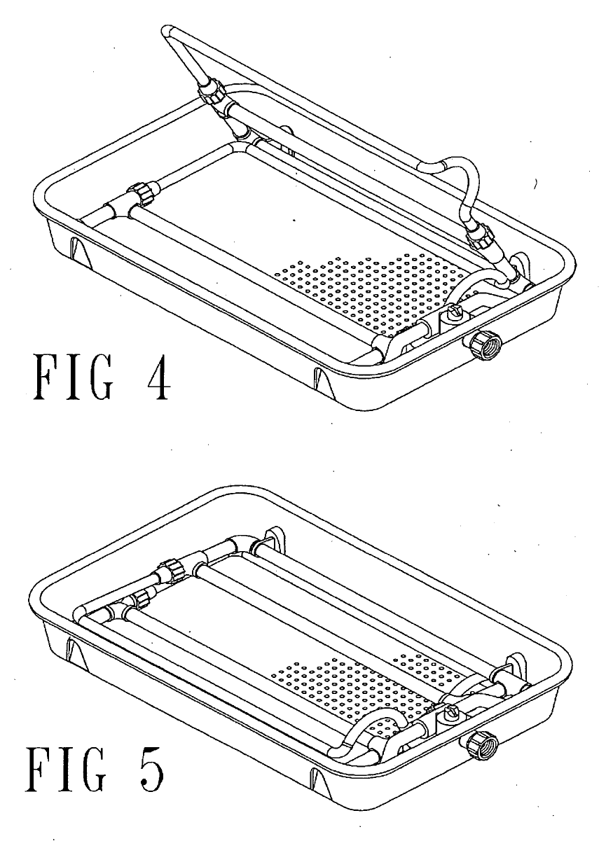

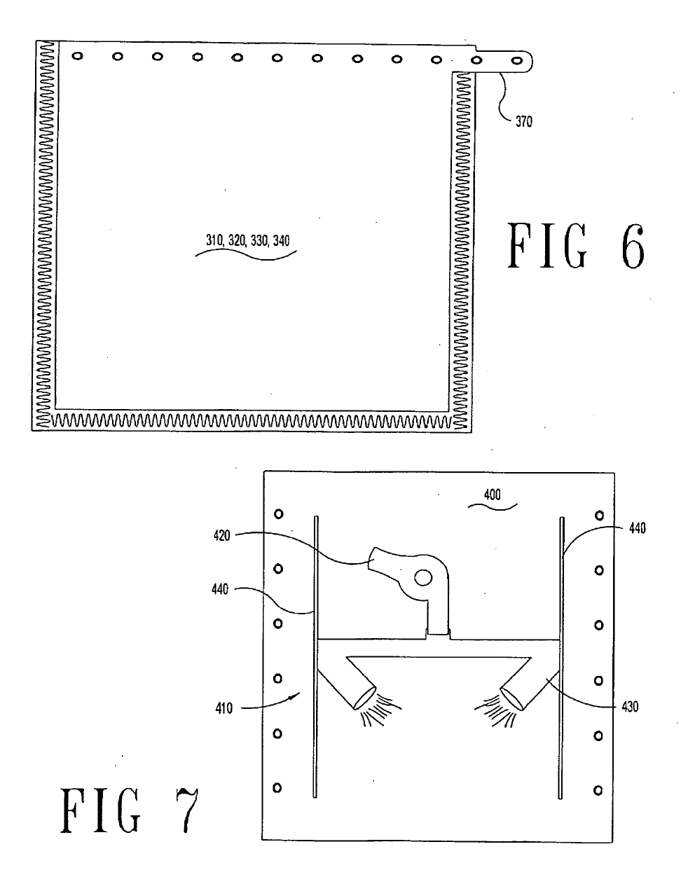

FIG. 2 shows the invention with the addition of the flexible enclosure 300. The flexible enclosure 300 has four side panels, the flexible enclosure left side 330, the flexible enclosure right side 340, the flexible enclosure forward side 310, and the flexible enclosure rear side 320. Each side panel of the flexible enclosure 300 has a plurality of snaps 350 around its perimeter, as well as a zipper 360 along each edge, as shown in FIG. 3. These snaps are used to connect the lower edge of each side panel 310, 320, 330, or 340 to the tub 10 as well as to each other. Additionally, the zippers 360 may be used to connect the edges of the side panels 310, 320, 330, and 340 together to form the overall flexible enclosure 300. Furthermore, referring to FIG. 6, each side panel may further include a tab 370 with fastening means, such as a snap, at one upper corner for securing the runner of the zipper 360 in its closed position. In the center of each side panel 310, 320, 330, or 340, a corresponding inlet 312, 322, 332, or 342 allows passage of air, the user's hands, or any other material to pass through the enclosure in a fashion that prevents water from easily exiting the invention. Each inlet consists essentially of an aperture in the corresponding panel with a sleeve extending from the aperture. Each panel and inlet combination can be and are preferably formed as a single, integral unit.

Referring to FIG. 7, a flexible enclosure top panel 400 may be added to the flexible enclosure 300 by attaching its edges to the top edges of the flexible enclosure side panels 310, 320, 330, and 340. The flexible enclosure top panel 400 may furthermore include a dryer system 410, including a blow dryer 420 (essentially an electric motor which turns a high-efficiency fan for moving large volumes of air, and which may include a heater) which is detachably connected to an air distribution tunnel 430. The air distribution tunnel 430 is suspended from a pair of dryer slides 440, each of which are mounted substantially parallel to each other on the lower surface of the flexible enclosure top panel 400. By this arrangement, a standard, commercially available blow dryer may be used to dry the hair of a pet after bathing. This arrangement keeps the animal in the controlled setting of the invention and prevents the animal from shaking or otherwise spreading water from the bathing operation.

The method of operation of the invention will be readily understood from the drawings and the foregoing description. Initially, the side panels 310, 320, 330, and 340 of the flexible enclosure are attached to the tub 10 and to each other. The tabs 370 may secure the zippers 360 from opening during use of the invention. Shampoo or other fur treatment chemical is place din the shampoo reservoir 30 if desired, and the mixing valve 32 is turned to the open position. A water hose is attached to the water inlet. The left and right water distribution frames 104 and 204 are each rotated up; the animal is placed in the center of the tub, with its head at the forward end, and the left and right water distribution frames are each rotated into place such that the left and right animal restraint water distribution frame tubes 140 and 240 are around the animal's neck. If necessary, the height of the left and right animal restraint water distribution frame tubes 140 and 240 may be adjusted by means of the telescoping action of the various water distribution frame end tubes, as described above. At this time, with the flexible enclosure side panels 310, 320, 330, and 340 sealed at each edge, including the top, the unit is ready for operation. Water is turned on, which mixes with shampoo at the mixing valve 32 (if desired), and is distributed around the animal through holes in the upper, middle, and lower water distribution tubes 120, 122, 124, 220, 222, and 224. When the animal is sufficiently wet and shampooed, the water is turned off to allow for lathering and the mixing valve 32 is turned to the off position so that pure water may be used to rinse the shampoo from the animal's fur. The flexible nature of the flexible enclosure 300, along with the presence of the inlets 312, 322, 332, and 342, allows for these actions without the need to open any of the seals. Excess water and fouled water drains through the tub drain holes 12. After lathering, the water is turned on, rinsing off the shampoo. After rinsing is complete, the top seal of the flexible enclosure 300 may be opened to allow for the flexible enclosure top panel 400 to be added to the flexible enclosure 300. The dryer system 410 may then be used to dry the pet, with the user moving the dryer system 410 back and forth approximately parallel to the orientation of the animal so that all parts of the animal are subjected to drying air. After drying, the flexible enclosure 300 is removed from the tub 10, and the left and right water distribution frames 104 and 204 are rotated down into a position substantially parallel to the bottom of the tub 10. The flexible enclosure 300 may then be placed around the tub and sealed for storage.

While the various parts of the invention may be formed from any suitably strong material, it is understood that the preferred material for the tub 10 and the flexible enclosure 300 is plastic. Those familiar with the art will understand the components of the invention, their methods of manufacture, and the methods of connecting them to form the complete invention. While the preferred embodiment has been described, it will furthermore be understood that various changes can be made therein without departing from the spirit and scope of the invention.

The invention claimed is:

1. A portable pet shower and dryer apparatus for washing a pet while containing the spread of water, shampoo, and washing chemicals, said pet shower and dryer apparatus further comprising:
a. a substantially rigid tub made of water impermeable material, with said tub having a water inlet for connecting to a water source and water drain holes in the bottom of said tub for draining liquid from said tub, and wherein said tub has a front side, a rear side, a left side, and a right side;
b. a reservoir for containing shampoo or other washing chemicals with a mixing valve for fluid communication between said reservoir and said water inlet;
c. two liquid distribution frames in fluid communication with said water inlet and said reservoir, wherein each of said liquid distribution frames is rotatably connected to a different side wall of said tub, and wherein each of said liquid distribution frames further comprises:
a plurality of liquid distribution tubes, wherein each liquid distribution tube is in fluid communication with said water inlet and said reservoir, and wherein each liquid distribution tube has a plurality of holes for dispensing liquid onto a pet contained within said apparatus, and
a curved support tube oriented such that when said liquid distribution tubes are rotated together, said curved support tube clamps around the neck of said pet contained within said apparatus;
d. a substantially flexible enclosure further comprising four side panels, wherein each of said side panels is made of a clear, water impermeable, flexible material, and wherein each of said side panels has connecting means along its bottom edge for releasably affixing said side panel to the top edge of the corresponding side of said tub, and wherein each of said side panels further has connecting means along each of its other edges for releasably affixing said side panel to each adjoining side panel.

2. The portable pet shower and drying apparatus of claim 1, wherein said flexible enclosure further comprises a top panel having connecting means along each of its edges for releasably affixing each of said edges of said top panel to the top edge of each corresponding side panel.

3. The portable pet shower and drying apparatus of claim 2, wherein said apparatus further comprises a drying device affixed to the bottom surface of said top panel.

4. The portable pet shower and drying apparatus of claim 3, wherein said drying device further comprises an electric air dryer having an air dryer outlet connected to and in fluid communication with an air distribution tube, with said air distribution tube further comprising a curved tube having one or more air outlets, wherein said air outlets are oriented toward a pet contained within said apparatus.

5. The portable pet shower and drying apparatus of claim 4, wherein said drying device is affixed to said bottom surface of said top panel by sliding means parallel to said left side and said right side of said tub, and wherein said drying device may be variably positioned by a user at any point along said sliding means.
